(19) United States
(12) Patent Application Publication
(10) Pub. No.: US 2025/0226430 A1
(43) Pub. Date: Jul. 10, 2025

(54) LAMINATION METHOD FOR FUEL CELL COMPONENTS

(71) Applicant: HONDA MOTOR CO., LTD., Tokyo (JP)

(72) Inventors: Ryotaro YAMAGAMI, Saitama (JP); Takumi YAMAHATA, Saitama (JP); Yusuke WADA, Saitama (JP); Taichi KITAGAWA, Saitama (JP)

(21) Appl. No.: 19/006,237

(22) Filed: Dec. 31, 2024

(30) Foreign Application Priority Data
Jan. 10, 2024 (JP) 2024-001847

(51) Int. Cl. H01M 8/1004; B32B 7/12; B32B 37/12

(52) U.S. Cl. CPC H01M 8/1004; B32B 7/12; B32B 37/1284; B32B 2457/18

(57) ABSTRACT

With the lamination method for fuel cell components, the gas diffusion layer is laminated to the intermediate layer during the manufacturing stage of a fuel cell that includes an intermediate layer and gas diffusion layers on both sides of the intermediate layer. The intermediate layer includes an electrolyte membrane and a resin film provided around the electrolyte membrane. With the method of laminating fuel cell components, a moisture-curing adhesive is applied to the resin film. Thereafter, the gas diffusion layer is brought into contact with the adhesive, thereby laminating the gas diffusion layer and the intermediate layer with the adhesive.

This application is based on and claims the benefit of priority from Japanese Patent Application No. 2024-001847, filed on 10 Jan. 2024, the content of which is incorporated herein by reference.

### BACKGROUND OF THE INVENTION

### Field of the Invention

The present invention relates to a method of laminating components that constitute a fuel cell.

### Related Art

Some fuel cells include, in sequence from one side, an anode-side gas diffusion layer, an intermediate layer, and a cathode-side gas diffusion layer. Such fuel cells generate electricity when a fuel gas containing hydrogen is supplied to the anode-side gas diffusion layer, and an oxidizing gas containing oxygen is supplied to the cathode-side gas diffusion layer.

Patent Document 1: Japanese Unexamined Patent Application, Publication No. 2023-161181

### SUMMARY OF THE INVENTION

The inventors of the present invention have focused on the following issues involved in the manufacturing stage of such fuel cells. Due to the structure of some fuel cells, while one of the gas diffusion layers can be joined to the intermediate layer through heat pressing, the other gas diffusion layer cannot be joined to the intermediate layer via heat pressing. In such cases, it is required to laminate the other gas diffusion layer to the intermediate layer with an adhesive.

Specifically, for example, the adhesive is applied to the intermediate layer, and the gas diffusion layer is laminated to the intermediate layer. However, in some cases, the area near the region where the adhesive is applied becomes an adhesive-restricted area. The adhesive-restricted areas refer to, for example, the electrode regions or the areas near the seal regions of the fuel cell.

Specifically, for instance, in a case where the adhesive spreads into the electrode region, the internal resistance of the fuel cell could be negatively affected. In a case where the adhesive spreads into the areas near the seal regions, the sealing performance of the fuel cell could be negatively affected.

In light of the above, the region where the adhesive is applied needs to be precisely controlled. Therefore, the intermediate layer and the gas diffusion layer of the fuel cell are preferably laminated as appropriately as possible.

The present invention has been made in view of the above circumstances and an object of the present invention is to facilitate lamination of the gas diffusion layer to the intermediate layer in an appropriate manner during the manufacturing stage of the fuel cell.

The inventors of the present invention have found that the above object can be achieved by using a moisture-curing adhesive in a proficient manner, leading to the present invention. The present invention is a lamination method for fuel cell components, as described in the following aspects (1) to (3).

(1) A lamination method for fuel cell components for laminating a gas diffusion layer to an intermediate layer during a manufacturing stage of a fuel cell that includes the intermediate layer and gas diffusion layers on both sides of the intermediate layer, in which

the intermediate layer includes an electrolyte membrane and a resin film provided around the electrolyte membrane, in which the method includes:
applying a moisture-curing adhesive to the resin film, and thereafter bringing the gas diffusion layer into contact with the adhesive, thereby laminating the gas diffusion layer and the intermediate layer with the adhesive.

While the resin film is unlikely to absorb moisture, the gas diffusion layer easily absorbs moisture. Therefore, with this aspect, at the time when the moisture-curing adhesive is applied to the resin film, the adhesive is unlikely to cure. Thereafter, when the gas diffusion layer is brought into contact with the moisture-curing adhesive, the moisture from the gas diffusion layer allows the adhesive to cure more easily. This can avoid situations where the adhesive cures prematurely before the gas diffusion layer is brought into contact with the adhesive, or situations where the adhesive is unlikely to cure even after the gas diffusion layer is brought into contact with the adhesive. These features facilitate the lamination of the gas diffusion layer to the intermediate layer in an appropriate manner.

(2) The lamination method for fuel cell components as described in (1), in which, after placing the gas diffusion layer on the adhesive, the gas diffusion layer is pressed against the intermediate layer with a pressing device, thereby allowing the adhesive to penetrate into the gas diffusion layer.

According to this aspect, by allowing the adhesive to penetrate into the gas diffusion layer, the curing speed of the moisture-curing adhesive can be accelerated. Furthermore, this pressing reduces the gap between the intermediate layer and the gas diffusion layer, allowing the intermediate layer and the gas diffusion layer to bond more closely. As a result, defects that may occur during the stacking of a plurality of fuel cells can be suppressed.

(3) The lamination method for fuel cell components as described in (2) further includes: preparing a jig that includes a lower jig with an upper surface configured to allow the intermediate layer to be arranged thereon, and an upper jig with a lower surface configured to allow the gas diffusion layer to be arranged thereon;

setting a state in which the gas diffusion layer is arranged on the lower surface of the upper jig, the intermediate layer is arranged on the upper surface of the lower jig, and the adhesive is applied to at least one of an upper surface of the intermediate layer or a lower surface of the gas diffusion layer; and
lowering the upper jig with a pressing device from the state to press the gas diffusion layer against the intermediate layer, thereby laminating the gas diffusion layer to the intermediate layer with the adhesive, while allowing the adhesive to penetrate into the gas diffusion layer.

According to this aspect, using such a jig allows the gas diffusion layer to be efficiently pressed against the intermediate layer.

As described above, according to the aspect (1), the gas diffusion layer can be more easily laminated to the intermediate layer during the manufacturing stage of the fuel cell. Furthermore, additional effects can be achieved according to the aspects (2) and (3) which reference the aspect (1).

### BRIEF DESCRIPTION OF THE DRAWINGS

FIG. 1 is a cross-sectional view illustrating a lamination jig for fuel cell components of the present embodiment;

FIG. 2 is a cross-sectional view illustrating a state where a gas diffusion layer is arranged on an upper surface of a lower jig;

FIG. 3 is a cross-sectional view illustrating a state where the gas diffusion layer is arranged on a lower surface of an upper jig;

FIG. 4 is a cross-sectional view illustrating a state where a receiving plate is arranged on the upper surface of the lower jig;

FIG. 5 is a cross-sectional view illustrating a state where an intermediate layer is arranged on the upper surface of the lower jig;

FIG. 6 is a cross-sectional view illustrating how the upper jig is lowered;

FIG. 7 is a cross-sectional view illustrating a state where the gas diffusion layer is brought into contact with an adhesive;

FIG. 8 is a cross-sectional view illustrating a state where the upper jig has been further lowered; and FIG. 9 is a cross-sectional view illustrating an internal structure of the fuel cell.

### DETAILED DESCRIPTION OF THE INVENTION

Hereinafter, embodiments of the present invention will be described with reference to the drawings. However, the present invention is not limited to the following embodiments, and can be appropriately modified and implemented within a scope that does not deviate from the spirit of the present invention.

### First Embodiment

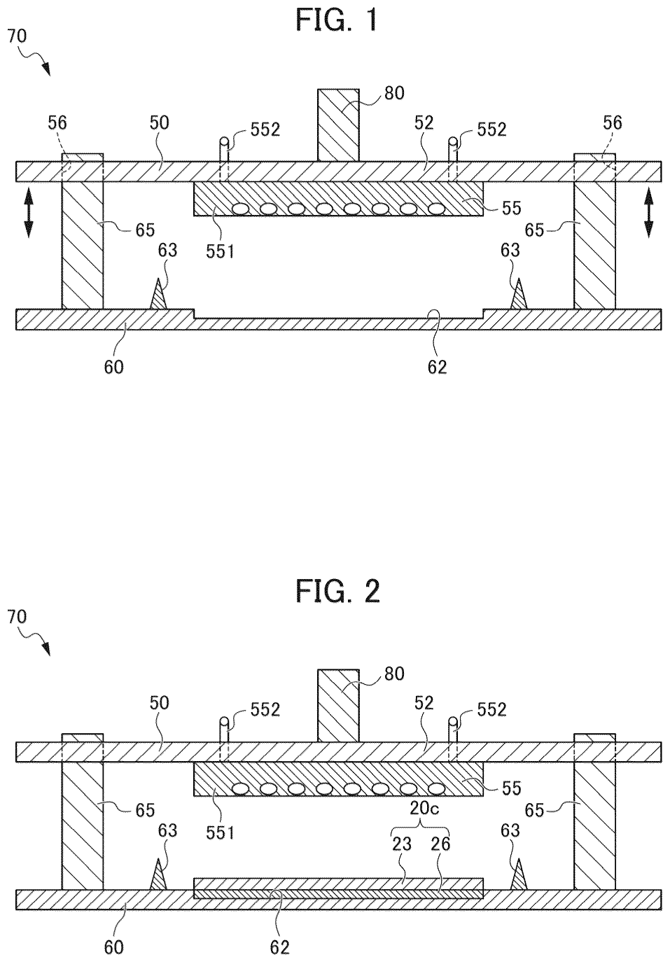

A lamination jig 70 for fuel cell components as illustrated in FIG. 1 is a jig for manufacturing a fuel cell 40. The lamination jig 70 for fuel cell components may be referred to simply as “jig”.

As illustrated in FIG. 9, the fuel cell 40 includes, in sequence from one side, an anode-side gas diffusion layer 20a, an intermediate layer 30, and a cathode-side gas diffusion layer 20c. The intermediate layer 30 may also be referred to as “UEA” or “unitized electrode assembly”.

The intermediate layer 30 includes a resin film 32 and an electrolyte membrane 35. The resin film 32 is a film for protecting the edge portion of the electrolyte membrane 35. Specifically, the resin film 32 consists of, for example, a first resin film located on the anode side of the electrolyte membrane 35, and a second resin film located on the cathode side of the electrolyte membrane 35. The resin film 32 includes a film window 32w for exposing portions other than the edge of the electrolyte membrane 35.

As illustrated in FIG. 9, each of the gas diffusion layers 20a, 20c includes carbon paper 23 and a porous layer 26. The porous layer 26 is provided closer to the intermediate layer 30 than the carbon paper 23.

The intermediate layer 30 is slightly larger than the gas diffusion layer 20c in a planar view. Accordingly, the edges of the intermediate layer 30 protrude from between the gas diffusion layers 20a and 20c. The anode-side gas diffusion layer 20a is attached to the intermediate layer 30 by heat pressing or the like. On the other hand, the cathode-side gas diffusion layer 20c is attached to the intermediate layer 30 using an adhesive A.

Hereinafter, the gas containing hydrogen will be referred to as “fuel gas,” and the gas containing oxygen will be referred to as “oxidizing gas”. During use of the fuel cell 40, the electrodes on both sides of the intermediate layer 30, i.e., the anode-side electrode and the cathode-side electrode, are electrically connected through a circuit that includes the power supply target. In this state, when the fuel gas is supplied to the anode-side gas diffusion layer 20a and the oxidizing gas is supplied to the cathode-side gas diffusion layer 20c, electricity is generated.

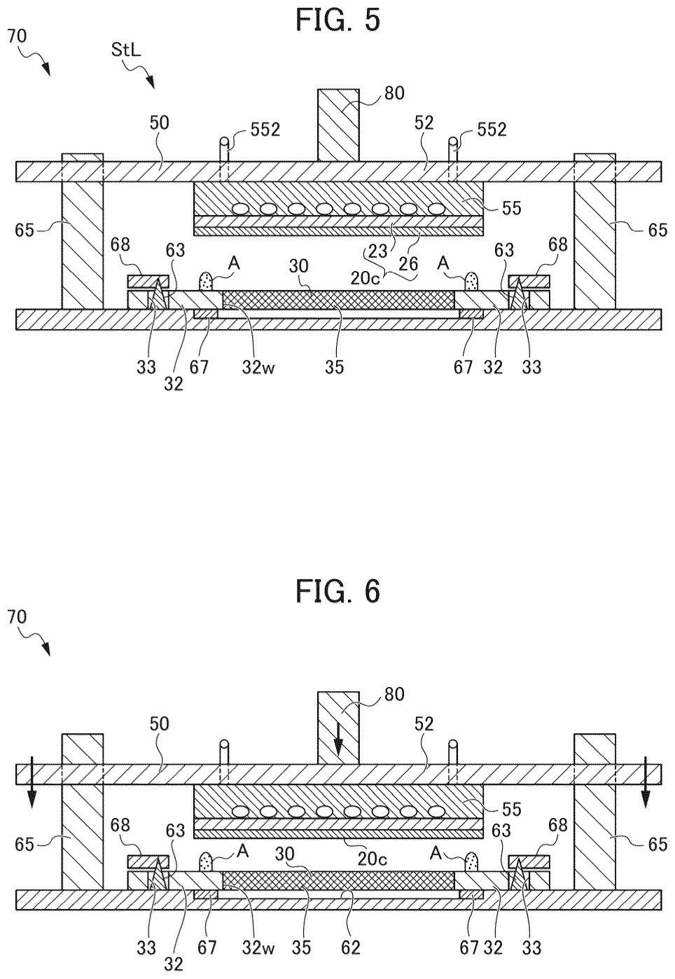

The lamination jig 70 for fuel cell components as illustrated in FIG. 1 is a jig for laminating the cathode-side gas diffusion layer 20c to the intermediate layer 30 during the manufacturing stage of the fuel cell 40 as illustrated in FIG. 9. Hereinafter, the cathode-side gas diffusion layer 20c will be referred to simply as the “gas diffusion layer 20c”. The lamination jig 70 for fuel cell components as illustrated in FIG. 1 includes an upper jig 50, a lower jig 60, a receiving plate 67 illustrated in FIG. 5, and a template 68.

As illustrated in FIG. 1, the lower jig 60 includes a plurality of guide shafts 65, a positioning recess 62, and a plurality of positioning pins 63.

Each guide shaft 65 extends upward from the upper surface of the lower jig 60. Each guide shaft 65 passes through a guided hole 56 provided in the upper jig 50. Thus, the upper jig 50 is vertically displaceably mounted on the lower jig 60 via the plurality of guide shafts 65.

As illustrated in FIG. 2, the positioning recess 62 is a recess for positioning the gas diffusion layer 20c relative to the lower jig 60. The positioning recess 62 has substantially the same shape and size as the gas diffusion layer 20c in a top view. As illustrated in FIG. 4, the receiving plate 67 is configured to be installable within the positioning recess 62.

As illustrated in FIG. 5, each positioning pin 63 is a pin for positioning the intermediate layer 30 relative to the lower jig 60. Specifically, each positioning pin 63 extends upward from the upper surface of the lower jig 60. The resin film 32 of the intermediate layer 30 includes a plurality of insertion holes 33. By inserting each positioning pin 63 into the corresponding insertion hole 33, the intermediate layer 30 is positioned relative to the lower jig 60. These positioning pins 63 may be referred to as “positioning parts”.

The template 68 is configured to be mountable on the upper surface of the intermediate layer 30 in areas that do not face the gas diffusion layer 20c in the state for lamination StL, which will be described later.

As illustrated in FIG. 1, a rod of a pressing device 80, such as an air cylinder, is attached to the upper jig 50. The upper jig 50 is configured to be vertically movable by way of the pressing device 80.

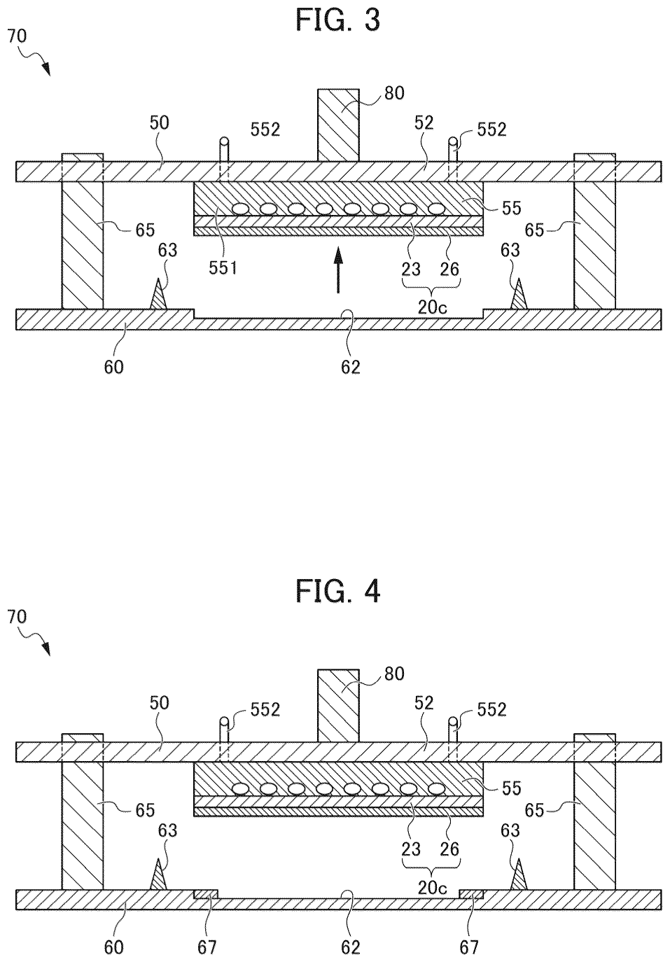

As illustrated in FIG. 2, the upper jig 50 includes a vacuum gripping mechanism 55. The vacuum gripping mechanism 55 includes a porous body 551 and a suction system 552. The porous body 551 is provided on the lower surface of the upper jig 50. When the vacuum gripping mechanism 55 is activated, the suction system 552 draws air from within the porous body 551. As a result, as illustrated in FIG. 3, the lower surface of the upper jig 50 vacuum-grips the gas diffusion layer 20c.

Hereinafter, as illustrated in FIG. 5, the state where the gas diffusion layer 20c is arranged on the lower surface of the upper jig, the intermediate layer 30 is arranged on the upper surface of the lower jig 60, and the adhesive A is applied to the upper surface of the intermediate layer 30, will be referred to as the “state for lamination StL”. Specifically, in the state for lamination StL of the present embodiment, the adhesive A is applied to both sides of the resin film 32 sandwiching the film window 32w, in a linear manner along the film window 32w. The lamination jig 70 for fuel cell components is configured to be settable to the state for lamination StL.

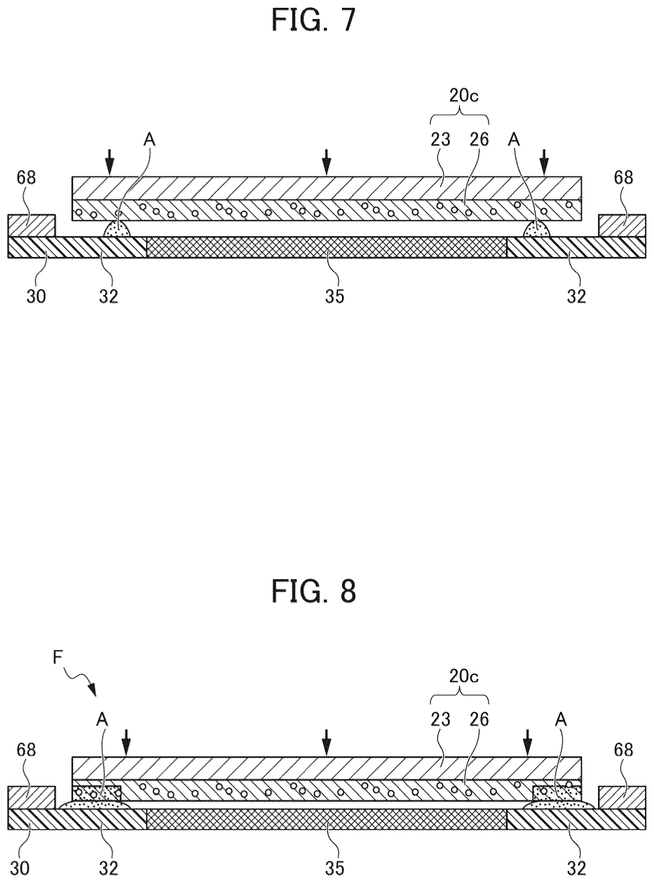

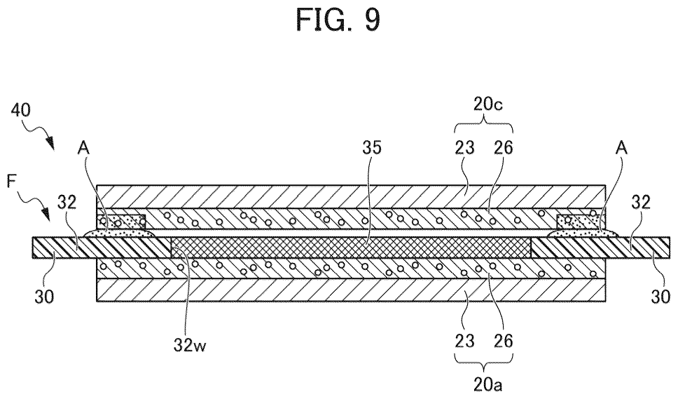

From the state for lamination StL, as illustrated in FIG. 6, when the upper jig 50 is lowered with the pressing device 80, the porous layer 26 of the gas diffusion layer 20c is pressed against the adhesive A on the intermediate layer 30, as illustrated in FIGS. 7 and 8.

The following describes the lamination method for fuel cell components, using the lamination jig 70 for fuel cell components as described above.

First, the operator prepares the lamination jig 70 for fuel cell components illustrated in FIG. 1.

Next, the operator prepares the gas diffusion layer 20c as illustrated in FIG. 2, and arranges the gas diffusion layer 20c on the lower jig 60 with the porous layer 26 facing downward. In this case, the gas diffusion layer 20c is positioned inside the positioning recess 62. As a result, the gas diffusion layer 20c is positioned at a designated location on the upper surface of the lower jig 60.

From this state, the operator activates the vacuum gripping mechanism 55, as illustrated in FIG. 3, thereby causing the lower surface of the upper jig 50 to vacuum-grip the gas diffusion layer 20c. As a result, the gas diffusion layer 20c is arranged at a designated location on the lower surface of the upper jig 50.

Next, the operator sets the predetermined receiving plate 67 into the positioning recess 62, as illustrated in FIG. 4.

Next, the operator prepares the intermediate layer 30 illustrated in FIG. 5. The moisture-curing adhesive A is applied to a designated portion of the upper surface of the resin film 32 of the intermediate layer 30. Specifically, the adhesive A is applied to both sides of the resin film 32 sandwiching the film window 32w, in a linear manner along the film window 32w. The manufacturing environment at this time is approximately 50% RH (23° C.).

Next, the operator arranges the intermediate layer 30 on the upper surface of the lower jig 60, as illustrated in FIG. 5. In this case, the positioning pins 63 are inserted into the corresponding insertion holes 33 of the intermediate layer 30. As a result, the intermediate layer 30 is positioned at a designated location on the upper surface of the lower jig 60. In this case, the receiving plate 67 is located directly below the adhesive A.

As a result, the previously described state for lamination StL is achieved. That is, the gas diffusion layer 20c is arranged on the lower surface of the upper jig 50, the intermediate layer 30 is arranged on the upper surface of the lower jig 60, and the adhesive A is applied to the upper surface of the intermediate layer 30. Next, the operator attaches the template 68 on the upper surface of the intermediate layer 30 in areas that do not face the gas diffusion layer 20c in the state for lamination StL.

Next, as illustrated in FIG. 6, the operator activates the pressing device 80 to lower the upper jig 50. As a result, the gas diffusion layer 20c, which is vacuum-gripped by the lower surface of the upper jig 50, comes into contact with the adhesive A on the upper surface of the intermediate layer 30, as illustrated in FIG. 7. As the upper jig 50 continues to lower, the gas diffusion layer 20c is pressed against the intermediate layer 30, as illustrated in FIG. 8. As a result, the adhesive A penetrates into the porous layer 26 of the gas diffusion layer 20c, and the gas diffusion layer 20c is laminated to the intermediate layer 30 using the adhesive A.

Afterwards, the operator deactivates the vacuum gripping mechanism 55 to release the pressure from the pressing device 80, and raises the upper jig 50 to remove an assembly F of the gas diffusion layer 20c and the intermediate layer 30 from the lamination jig 70 for fuel cell components. The anode-side gas diffusion layer 20a illustrated in FIG. 9, is then joined to the intermediate layer 30 of this assembly F by heat pressing.

The features and effects of the present embodiment are summarized below.

As illustrated in FIG. 5, after setting the state for lamination StL as previously described, the gas diffusion layer 20c can be laminated to the intermediate layer 30 using the adhesive A simply by lowering the upper jig 50 as illustrated in FIG. 6, and pressing the gas diffusion layer 20c against the intermediate layer 30 as illustrated in FIGS. 7 and 8. Therefore, compared to cases without using such a lamination jig 70 for fuel cell components, the intermediate layer 30 and the gas diffusion layer 20c can be more easily laminated in an efficient manner.

As illustrated in FIG. 6, the upper jig 50 is vertically displaceably mounted on the lower jig 60 via the guide shafts 65, which extend vertically. Therefore, the guide shafts 65 facilitate correct alignment of the upper jig 50 with the lower jig 60. This aspect also facilitates the efficient lamination of the gas diffusion layer 20c to the intermediate layer 30. Furthermore, this aspect facilitates lamination of the gas diffusion layer 20c to the intermediate layer 30 in the correct relative position with high accuracy.

As illustrated in FIG. 2, the upper jig 50 includes the vacuum gripping mechanism 55. The vacuum-gripping by the vacuum gripping mechanism 55, as illustrated in FIG. 3, allows the gas diffusion layer 20c to be arranged on the lower surface of the upper jig 50. Therefore, the vacuum-gripping allows the gas diffusion layer 20c to be arranged on the lower surface of the upper jig 50 against gravity. This aspect also facilitates the efficient lamination of the gas diffusion layer 20c to the intermediate layer 30.

As illustrated in FIG. 1, the upper surface of the lower jig 60 includes the positioning recess 62 for positioning the gas diffusion layer 20c. Therefore, as illustrated in FIG. 2, after positioning the gas diffusion layer 20c in the positioning recess 62 of the lower jig 60, the gas diffusion layer 20c can be arranged at a designated location on the lower surface of the upper jig 50 simply by causing the lower surface of the upper jig 50 to vacuum-grip the gas diffusion layer 20c, as illustrated in FIG. 3. This aspect also facilitates the efficient lamination of the gas diffusion layer 20c to the intermediate layer 30 in the correct relative position with high accuracy.

As illustrated in FIG. 5, the upper surface of the lower jig 60 includes the positioning pins 63 for positioning the intermediate layer 30. The positioning pins 63 allow the intermediate layer 30 to be easily arranged at a designated location on the upper surface of the lower jig 60. This aspect also facilitates the efficient lamination of the gas diffusion layer 20c to the intermediate layer 30 in the correct relative position with high accuracy.

As illustrated in FIG. 5, the template 68 is configured to be mountable on areas of the upper surface of the intermediate layer 30 that do not face the gas diffusion layer 20c in the state for lamination StL. The template 68 can suppress warping of the intermediate layer 30. This aspect also facilitates the efficient lamination of the gas diffusion layer 20c to the intermediate layer 30 in the correct relative position with high accuracy.

In a case where the adhesive A illustrated in FIG. 8, seeps from between the gas diffusion layer 20c and the intermediate layer 30 toward the template 68, the adhesive A will reach the template 68. This prevents the adhesive A from spreading beyond the template 68 into the adhesive-restricted areas described later.

while the resin film 32 illustrated in FIG. 7 is unlikely to absorb moisture, the porous layer 26 of the gas diffusion layer 20c easily absorbs moisture. Therefore, as illustrated in FIG. 5, at the time when the moisture-curing adhesive A is applied to the resin film 32, the adhesive A is unlikely to cure. Then, as illustrated in FIG. 7, when the porous layer 26 of the gas diffusion layer 20c comes into contact with the moisture-curing adhesive A, the moisture in the porous layer 26 facilitates the curing of the adhesive A. This can avoid situations where the adhesive A cures prematurely before the gas diffusion layer 20c is brought into contact with the adhesive A, or situations where the adhesive A is unlikely to cure even after the gas diffusion layer 20c is brought into contact with the adhesive A. This facilitate the lamination of the gas diffusion layer 20c to the intermediate layer 30 in an appropriate manner.

This facilitates the reduction in the total amount of the adhesive A applied, and also facilitates suppression of the width of the adhesive A applied. This can prevent the adhesive A from spreading beyond the desired application area when the gas diffusion layer 20c is laminated to the resin film 32. Consequently, the adhesive A can be prevented from spreading into the adhesive-restricted areas of the fuel cell 40.

Specifically, the adhesive-restricted areas referred to here include, for example, the electrode regions and the areas near the seal regions of the fuel cell 40 illustrated in FIG. 9. The electrode regions are areas on both sides of the electrolyte membrane 35, along the thickness direction thereof. On the other hand, the seal regions are areas where a plurality of cover members (not illustrated) that cover the intermediate layer 30 and the gas diffusion layers 20a, 20c are joined together. Therefore, the areas near the seal regions are the areas near the portions protruding from between the gas diffusion layers 20a and 20c of the intermediate layer 30. Thus, when the adhesive A is applied, the electrode regions and the areas near the seal regions are located on horizontally both sides of the application area.

Thus, according to the present embodiment, using the moisture-curing adhesive A can prevent the adhesive A from spreading into the electrode regions and the areas near the seal regions on both sides of the adhesive A. This can suppress adverse effects on internal resistance of the fuel cell 40 caused by the adhesive A spreading into the electrode regions, as well as adverse effects on sealing performance of the fuel cell 40 caused by the adhesive A spreading into the areas near the seal regions.

As illustrated in FIG. 7, after the gas diffusion layer 20c is placed on the adhesive A, the gas diffusion layer 20c is pressed against the intermediate layer 30, as illustrated in FIG. 8, causing the adhesive A to penetrate into the porous layer 26 of the gas diffusion layer 20c. This penetration can accelerate the curing speed of the moisture-curing adhesive A. Furthermore, this pressing reduces the gap between the intermediate layer 30 and the gas diffusion layer 20c, allowing the intermediate layer 30 and the gas diffusion layer 20c to bond more closely. As a result, defects that may occur during the stacking of a plurality of fuel cells 40 can be suppressed.

### Other Embodiments

The above embodiment can be modified, for example, as follows:

Contrary to the sequence in the first embodiment, the anode-side gas diffusion layer 20a illustrated in FIG. 9, may be joined to the intermediate layer 30 by heat pressing first, and then the above lamination method for fuel cell components may be applied to laminate the cathode-side gas diffusion layer 20c to the intermediate layer 30 using the adhesive A.

The above lamination method for fuel cell components may be automated using a robot. Instead of the positioning pins 63 illustrated in FIG. 5, positioning parts such as grooves or locking parts may be provided. Instead of the vacuum gripping mechanism 72 illustrated in FIG. 3, clamps or similar devices may be provided to fix the gas diffusion layer 20c to the lower surface of the upper jig 50.

### Explanation of Reference Numerals

20c: cathode-side gas diffusion layer

30: intermediate layer

32: resin film

35: electrolyte membrane

40: fuel cell

50: upper jig

55: vacuum gripping mechanism

60: lower jig

62: positioning recess

63: positioning pin (positioning part)

65: guide shaft

68: template

80: air cylinder (pressing device)

A: adhesive

StL: state for lamination (state)

What is claimed is:

1. A lamination method for fuel cell components for laminating a gas diffusion layer to an intermediate layer during a manufacturing stage of a fuel cell that includes the intermediate layer and gas diffusion layers on both sides of the intermediate layer, the intermediate layer including an electrolyte membrane and a resin film provided around the electrolyte membrane, the method comprising:
applying a moisture-curing adhesive to the resin film, and
thereafter bringing the gas diffusion layer into contact with the adhesive, thereby laminating the gas diffusion layer and the intermediate layer with the adhesive.

2. The lamination method for fuel cell components according to claim 1, wherein, after placing the gas diffusion layer on the adhesive, the gas diffusion layer is pressed against the intermediate layer with a pressing device, thereby allowing the adhesive to penetrate into the gas diffusion layer.

3. The lamination method for fuel cell components according to claim 2, further comprising:
preparing a jig that includes a lower jig with an upper surface configured to allow the intermediate layer to be arranged thereon, and an upper jig with a lower surface configured to allow the gas diffusion layer to be arranged thereon;
setting a state in which the gas diffusion layer is arranged on the lower surface of the upper jig, the intermediate layer is arranged on the upper surface of the lower jig, and the adhesive is applied to at least one of an upper surface of the intermediate layer or a lower surface of the gas diffusion layer; and
lowering the upper jig with the pressing device from the state to press the gas diffusion layer against the intermediate layer, thereby laminating the gas diffusion layer to the intermediate layer with the adhesive, while allowing the adhesive to penetrate into the gas diffusion layer.
